(19) United States
(12) Patent Application Publication
(10) Pub. No.: US 2018/0321075 A1
(43) Pub. Date: Nov. 8, 2018

(54) Zeroing a Target Flowmeter

(71) Applicant: CDI Meters, Inc., Woburn, MA (US)

(72) Inventor: Roger E. Dennison, Lexington, MA (US)

(21) Appl. No.: 15/969,589

(22) Filed: May 2, 2018

Related U.S. Application Data
(60) Provisional application No. 62/500,260, filed on May 2, 2017.

(51) Int. Cl. G01F 25/00

(52) U.S. Cl. CPC G01F 25/0007; G01F 1/08

(57) ABSTRACT

A system and method of automatically zeroing a target flowmeter wherein a lack of variation in the raw flow signal is taken as an indication of lack of turbulence, and thus of an extremely low-flow condition under which automatic zeroing may be performed.

### CROSS-REFERENCE TO RELATED APPLICATION

This application claims priority of Provisional Application 62/500,260 filed on May 2, 2017, the entire contents of which are incorporated by reference herein.

### FIELD

This application relates to automatically zeroing a target flowmeter.

### BACKGROUND

A target flowmeter configured for bi-directional operation generates a force signal, F, that increases as flow varies from its maximum negative value through zero to its maximum positive value. The value of F at zero flow, F₀, must be known with good accuracy in order for the meter to perform well, particularly at low flow rates. The flowmeter is zeroed by establishing the value of F₀, usually at the time of installation. F₀ may vary as dirt accumulates on the flow-sensing element, as creep occurs in the mechanical elements, and as the force-sensing element, usually a strain gauge, and the electronics, drift over time. Consequently, an automatic zeroing process is useful to maintain the accuracy of the instrument.

### SUMMARY

The present disclosure relates to determining when flow is equal to or close to zero, and thus conditions are appropriate for zeroing the flowmeter by setting F_{off}, the estimated value of F₀, equal to, or progressively closer to, the current value of F. See the definitions of these and other variables, below. Two methods of detecting zero-flow conditions are disclosed, with the intent that the first be used alone, or that the two be used in combination.

The first method relies on detecting changes in a drag force caused by a moving fluid (e.g., compressed air). When there is no flow past the meter, the drag force on the target element is zero, and thus constant. If there is a very small and constant flow in either direction the flow will be laminar and the force will again be constant. At higher flows, the flow will become turbulent and the turbulence will result in a varying force on the target element. If detectable turbulence occurs at sufficiently low flow rates, the absence of variations in the force can be used as a criterion for determining when zeroing can be applied. Furthermore, even with laminar flows, a change in the drag force is an indication that flow is changing, and therefor present.

The second method relies on the fact that the pressure in most compressed-air systems drops to atmospheric from time to time, in some cases because of nightly shutdowns and in some cases due to periodic maintenance. When a system is at atmospheric pressure there is normally no flow, though there is flow as its pressure drops close to atmospheric pressure and as its pressure rises after the shutdown. As will be seen, by sensing both pressure and changes in force, one can reliably distinguish periods when flow is essentially zero. Zeroing of the meter can be performed during such periods.

All examples and features mentioned below can be combined in any technically possible way.

In one aspect, a system for automatically zeroing a target flowmeter includes a target element that is configured to be placed into a fluid flow and generate an output signal that is related to a sensed force on the target element due to the fluid flow, and a processor that is configured to determine, based on the target element output signal, a condition where the fluid flow is zero or essentially zero, determine a no-flow target element output signal during the condition where the flow is zero or essentially zero, and determine, based on a change in the target element output signal from its no-flow value, a fluid flow rate.

Embodiments may include one of the following features, or any combination thereof. The processor may be configured to determine the condition where the fluid flow is zero or essentially zero further based on a drag force on the target element. The processor may be configured to determine the condition where the fluid flow is zero or essentially zero further when the drag force on the target element is zero. The processor may be configured to determine the condition where the fluid flow is zero or essentially zero further based on variations in the drag force on the target element. The processor may be configured to determine that the fluid flow is not zero when drag force variations are detected.

Embodiments may include one of the above and/or below features, or any combination thereof. The system may further include circuitry for determining, based on the target element output signal, a force signal. The system may further include a temperature sensor that is configured to sense the temperature of the fluid flow in a conduit. The processor may be responsive to the temperature sensor and the force signal. The processor may be further configured to determine a force offset value. The force offset value may include an estimate of the no-flow target element output signal. The processor may be further configured to determine, based on the sensed temperature, a temperature compensation value. The processor may be further configured to incrementally adjust a value of a combination of the force signal, the temperature compensation value, and the estimate of the no-flow target element output signal.

Embodiments may include one of the above and/or below features, or any combination thereof. The system may further include circuitry for determining, based on the target element output signal, a force signal. The system may further include a pressure sensor that is configured to sense the pressure of the fluid flow in a conduit. The processor may be responsive to the temperature sensor, the pressure sensor, and the force signal. The processor may be configured to determine the no-flow target element output signal only when the sensed pressure is within a predetermined pressure range. The predetermined pressure range may be around atmospheric pressure.

### BRIEF DESCRIPTION OF THE DRAWINGS

Other objects, features and examples will occur to those skilled in the art from the following description and the accompanying drawings, in which:

FIG. 1 is a sectional view showing components of the measurement portion of a flowmeter that can be used in the present system and methods.

FIG. 2 is a schematic illustration of a flowmeter that can be used in the present system and methods.

FIG. 3 is a plot of the relationship between the force sensed by the force-sensing element and the flow rate past the meter.

FIG. 4 is a flowchart showing a method of the present disclosure.

### DETAILED DESCRIPTION

This disclosure pertains to systems and methods of automatically zeroing a target flowmeter by sensing conditions under which flow is essentially zero and setting the force offset, or the value of the sensed force at no flow, to the force observed under those conditions.

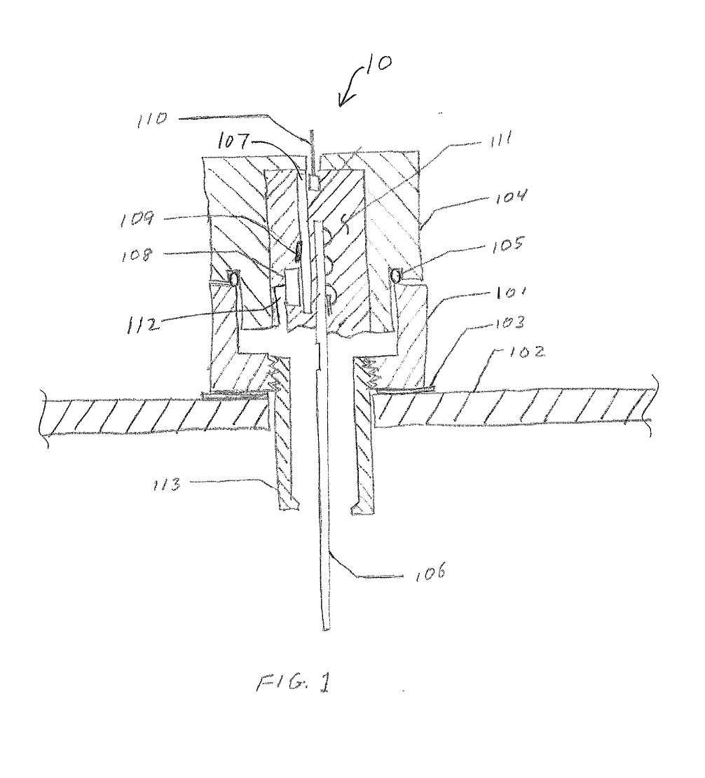

FIG. 1 illustrates components of a flowmeter 10. This is only one non-limiting example of a flowmeter that can be used in the present disclosure. A split ring 101 mounts to pipe 102 and seals to it by means of gasket 103. A pressure-containing chamber 122 is formed between a recess in the split ring and cover piece 104, which seals to the split ring by means of o-ring 105. Flow-sensing vane 106 is mounted to circuit board 107, to which are also mounted absolute pressure sensor 108 and a temperature sensor, such as a surface-mount RTD, 109. The temperature sensor may, alternatively, be located at a point directly exposed to the fluid. One or more pins 110 projecting from the enclosure, are used to connect the circuit board to remote electronics (not shown) that provide power and receive signals to calculate flow.

The space within cover piece 104 and surrounding circuit board 107 is filled with a potting material 111 selected to be highly resistant to moisture. This potting material covers the circuit board and the electrical connections to the sensing vane; passage 112 that is open to volume 122 and pipe interior 121 allows fluid pressure in the pipe to reach the pressure sensor.

Protective shield 113 limits the range of movement of vane 106 and reduces the likelihood of damage to the vane by objects traveling with the fluid. Such protective shields are known in the art of flowmeters and so are not further described herein.

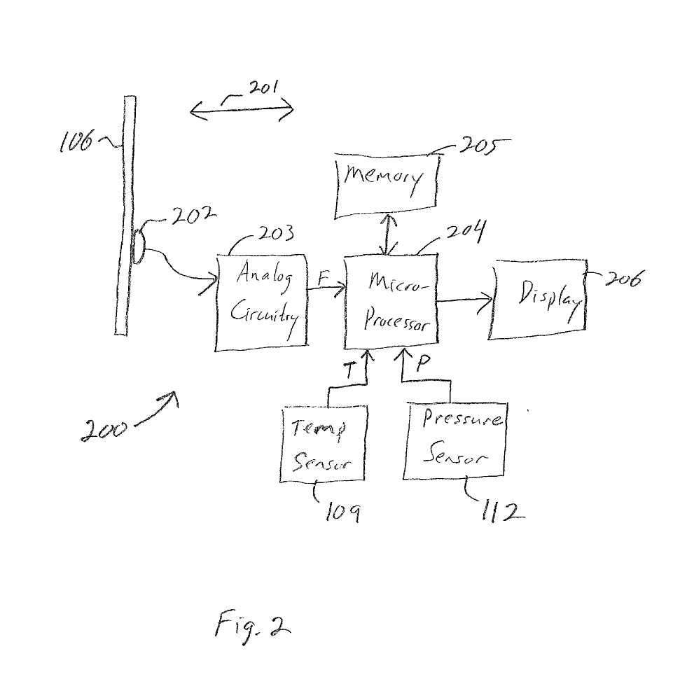

FIG. 2 is a schematic illustration showing elements 200 of a flowmeter (such as flowmeter 10, FIG. 1) that can be used in the flow-measurement systems and methods. Flow-sensing vane 106 is exposed to a fluid that many be moving in either direction, as indicated by arrow 201. It is preferred that the vane 106 have low mass, so that it will be responsive to the variations in force caused by turbulence in the flow. The vane is held in place by circuit board 107 (not shown) and it flexes in response to the flow, this flexing being sensed by strain gauge 202. Analog circuitry 203 provides a signal representing the force on the vane to microprocessor 204. Temperature sensor 109 and pressure sensor 112 provide fluid temperature and pressure signals, respectively, to the microprocessor. Non-volatile memory 205 is used by the microprocessor to store calibration data and offset data when power is not available. The calculated flow is shown on digital display 206.

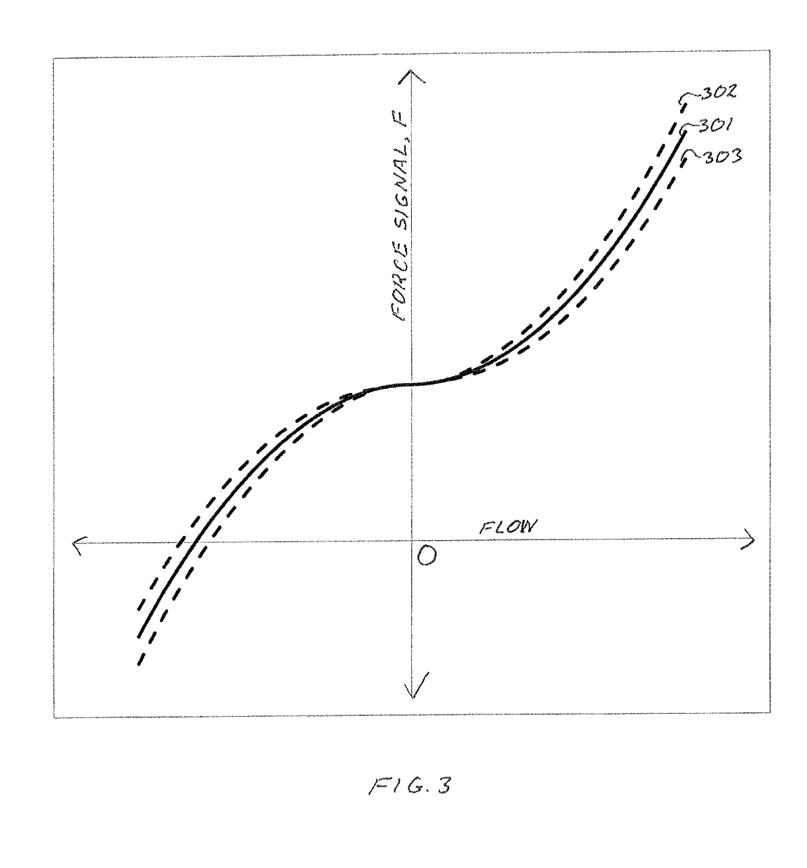

FIG. 3 illustrates examples of the variation in the force signal, F, with flow rate. The force signal is the sum of the drag force of the fluid on the vane, the effect of gravitational pull on the vane, and any offset in the analog circuitry. The drag force is, to a close approximation, proportional to the square of the velocity multiplied by the sign of the flow rate and the density of the fluid. The force fluctuates due to turbulence. The average of the force signal is indicated by the solid line, 301, while the range over which the force commonly varies is indicated by the upper and lower dashed lines, 302 and 303. As the flow rate approaches zero from either direction, the Reynolds number decreases and the flow becomes laminar, eliminating the variations in the force on the vane. Thus, when the flow is zero or close to zero, there will be little or no noise in the force signal, and successive samples of the force signal will usually be equal. Thus, successive equal or substantially equal values of F can be indicative of zero flow, or essentially zero flow where the actual flow is trivial. The flowmeter can be zeroed once this zero-flow condition has been detected. It is evident from FIG. 3 that, at low flow rates, a slight change in force corresponds to a relatively large change in flow. For this reason, it is important, for accurate low-flow measurements, that F₀ be known with the best accuracy possible.

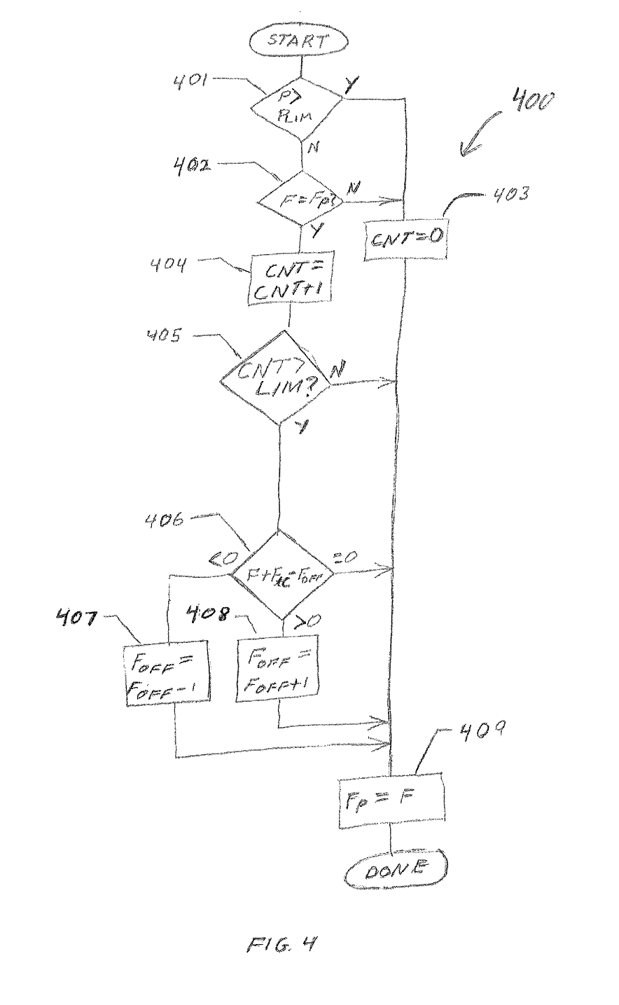

FIG. 4 is a flowchart showing one simple but effective non-limiting exemplary method of implementing an auto-zeroing process 400 that can be accomplished under the present disclosure. The process of zeroing the flowmeter consists of detecting a zero-flow condition (or an essentially zero-flow condition) and then incrementally adjusting F_{off} to bring the expression (F+F_{tc}−F_{off}) toward and eventually to zero. FIG. 4 shows the process if both the first and the second method are implemented. If only the first is implemented, step 401 is omitted.

We define the following:
F the current force signal from the analog circuit, as represented in the microprocessor
F₀ the value of the force signal when there is no flow
Fₚ the previous value of F, stored by the microprocessor
F_{off} the current estimate of F₀, the offset value to be used in calculating flow
F_{tc} a temperature-compensation value, calculated as a function of temperature
CNT a counter for the number of successive equal values of F that have occurred
LIM the number of successive equal values of F that will establish zero flow
P the pressure in the system
Pₗᵢₘ a system pressure above which zeroing will not be performed

The process 400 illustrated in FIG. 4 is executed at some pre-determined interval, perhaps once a second, using the then-current values of force F and pressure P. The process proceeds as follows.

If the pressure limit is included, the microprocessor compares the current system pressure, P, with the chosen limit, Pₗᵢₘ, step 401. If the pressure is above the limit, the microprocessor proceeds to step 403 and sets the counter of successive equal force values, CNT, to zero. If a pressure limit is not included, or if the pressure is below or equal to the limit, the microprocessor compares F with Fₚ, step 402. If the two are not equal, it sets the counter CNT to zero, step 403 and proceeds to step 409. If they are equal, it increments the counter step 404 and compares it with the limit, (LIM) step 405. If the counter is less than or equal to the limit, it proceeds to step 409. If it exceeds the limit, the microprocessor calculates (F+F_{tc}−F_{off}), step 406. If the result is less than zero, it reduces F_{off} by one count, step 407, and proceeds to step 409; if it is greater than zero, the microprocessor increases F_{off} by one count, step 408, and proceeds to step 409. If the value is equal to zero, it proceeds directly to step 409. It then sets Fₚ equal to F step 409, storing F for comparison on the next measurement cycle.

In some applications, F may vary due to electrical noise or vibration and the comparison at step 402 may need to look for agreement within a range rather than exact equality. Such range could be determined by one skilled in the field.

The method need only occasionally detect no-flow conditions; it can fail to detect such conditions often and still work properly. It must not, however, indicate no flow when there is indeed substantial flow.

### Application of the Systems and Methods of the Present Disclosure Under Various Circumstances

Case 1: System pressurized continuously, flow stops completely from time to time.

This would be the case when monitoring air leaving a compressor that cycles on and off. With the compressor running, flow would be readily detected from its turbulence; with it off, a constant zero-flow condition would be clear. It would be unusual for there to be leakage flow at this point in the system. Zeroing would be performed based on the lack of flow variation alone, as in the first method described above.

Case 2: System periodically shut down and de-pressurized.

This case would cover systems with night or weekend shutdowns and those with other periodic shutdowns for maintenance that are otherwise run continuously. In this case, the pressure limit would be applied and set just above atmospheric pressure. The meter might be incorrectly zeroed as the system pressure dropped below the limit with some flow still present, but this would be corrected when the pressure reached atmospheric and there was indeed no flow. As the system was filled following the shutdown, the flow would quickly begin to rise and the change in force would be detected, causing the value of CNT to be set to zero and delaying re-zeroing until turbulent flow developed or the pressure was above Pₗᵢₘ.

Case 3: Distribution metering with system never shut down.

In this case, the flowmeter would be installed, and powered, well before the system was pressurized, thereby allowing accurate zeroing at the outset.

If the system and method of the present disclosure fails to detect zero flow when there is no flow some, or even much of the time, it will still work properly, because drift is slow, and zeroing need only occur at infrequent intervals.

Once the meter is zeroed, the quantity (F+F_{tc}−F_{off}) is a very close approximation to the force exerted by the moving fluid on the vane.

If the fluid is known and can be approximated as an ideal gas, its density, p, can be calculated as:

$$ρ = \frac{P}{( R * T )}$$

where R is the appropriate gas constant. The force on the vane varies with the product of a drag coefficient, C_{D}, the density, and the square of the velocity. The velocity can be calculated as:

$$V = C * {\{ \frac{( F + Ftc - {F}_{off} )}{ρ} \}}^{1 / 2}$$

where C is determined by calibration. Commonly, mass flow is required and the meter is calibrated in overall flow rather than point velocity. Mass flow is given by:

$$G = A * ρ * {\{ \frac{F + Ftc - {F}_{off}}{ρ} \}}^{1 / 2}$$

Again, the coefficient A is determined by calibration.

A number of implementations have been described. Nevertheless, it will be understood that additional modifications may be made without departing from the scope of the inventive concepts described herein, and, accordingly, other embodiments are within the scope of the following claims.

What is claimed is:

1. A system for automatically zeroing a target flowmeter, comprising:
a target element that is configured to be placed into a fluid flow and generate an output signal that is related to a sensed force on the target element due to the fluid flow; and
a processor that is configured to:
determine, based on the target element output signal, a condition where the fluid flow is zero or essentially zero;
determine a no-flow target element output signal during the condition where the flow is zero or essentially zero; and
determine, based on a change in the target element output signal from its no-flow value, a fluid flow rate.

2. The system for automatically zeroing a target flowmeter of claim 1, wherein the processor is configured to determine the condition where the fluid flow is zero or essentially zero further based on a drag force on the target element.

3. The system for automatically zeroing a target flowmeter of claim 2, wherein the processor is configured to determine the condition where the fluid flow is zero or essentially zero further when the drag force on the target element is zero.

4. The system for automatically zeroing a target flowmeter of claim 2, wherein the processor is configured to determine the condition where the fluid flow is zero or essentially zero further based on variations in the drag force on the target element.

5. The system for automatically zeroing a target flowmeter of claim 4, wherein the processor is configured to determine that the fluid flow is not zero when drag force variations are detected.

6. The system for automatically zeroing a target flowmeter of claim 1, further comprising circuitry for determining, based on the target element output signal, a force signal.

7. The system for automatically zeroing a target flowmeter of claim 6, further comprising a temperature sensor that is configured to sense the temperature of the fluid flow in a conduit.

8. The system for automatically zeroing a target flowmeter of claim 7, wherein the processor is responsive to the temperature sensor and the force signal.

9. The system for automatically zeroing a target flowmeter of claim 8, wherein the processor is further configured to deteiniine a force offset value.

10. The system for automatically zeroing a target flowmeter of claim 9, wherein the force offset value comprises an estimate of the no-flow target element output signal.

11. The system for automatically zeroing a target flowmeter of claim 10, wherein the processor is further configured to determine, based on the sensed temperature, a temperature compensation value.

12. The system for automatically zeroing a target flowmeter of claim 11, wherein the processor is further configured to incrementally adjust a value of a combination of the force signal, the temperature compensation value, and the estimate of the no-flow target element output signal.

13. The system for automatically zeroing a target flowmeter of claim 12, wherein the processor is configured to incrementally adjust toward zero the value of the combination of the force signal, the temperature compensation value, and the estimate of the no-flow target element output signal.

14. The system for automatically zeroing a target flowmeter of claim 6, further comprising a pressure sensor that is configured to sense the pressure of the fluid flow in a conduit.

15. The system for automatically zeroing a target flowmeter of claim 14, wherein the processor is responsive to the temperature sensor, the pressure sensor, and the force signal.

16. The system for automatically zeroing a target flowmeter of claim 15, wherein the processor is configured to determine the no-flow target element output signal only when the sensed pressure is within a predetermined pressure range.

17. The system for automatically zeroing a target flowmeter of claim 16, wherein the predetermined pressure range is around atmospheric pressure.
